(19) United States
(12) Patent Application Publication
(10) Pub. No.: US 2014/0089661 A1
(43) Pub. Date: Mar. 27, 2014

(54) SYSTEM AND METHOD FOR SECURING NETWORK TRAFFIC

(71) Applicant: Securly, Inc., Milpitas, CA (US)

(72) Inventors: Vinay Mahadik, Milpitas, CA (US); Bharath Madhusudan, Sunnyvale, CA (US)

(73) Assignee: Securly, Inc., Milpitas, CA (US)

(21) Appl. No.: 14/034,961

(22) Filed: Sep. 24, 2013

Related U.S. Application Data
(60) Provisional application No. 61/705,514, filed on Sep. 25, 2012.

(51) Int. Cl. H04L 29/06; H04L 9/06

(52) U.S. Cl. CPC H04L 63/0281; H04L 9/0643
USPC 713/162; 726/12

(57) ABSTRACT

One variation of a method for selectively filtering internet traffic includes: receiving DNS queries; determining resource access levels for the DNS queries based on an internet resource database, wherein the resource access levels comprise a first level, a second level, and a third level returning an unmodified IP address for the first level DNS queries; returning a replacement resource IP address for the second level DNS queries; returning a web proxy server IP address for the third level DNS queries; and regulating HTTP traffic directed to the web proxy server IP address.

### CROSS-REFERENCE TO RELATED APPLICATIONS

This application claims the benefit of U.S. Provisional Application Ser. No. 61/705,514, filed on 25 Sep. 2012, which is incorporated in its entirety by this reference.

### TECHNICAL FIELD

This invention relates generally to the internet security field, and more specifically to a new and useful system and method for securing network traffic in the internet security field.

### BACKGROUND

Homes, businesses, schools, and other institutions often want to provide a safe kid or work friendly internet browsing environment. Traditional approaches may include Mocking specific sites that are deemed inappropriate for particular audiences. However, many sites have beneficial and appropriate uses such as search engines and sites with user generated content. Simply Mocking access to a domain can be too restrictive for some sites. Security appliances are another common approach to securing a browsing environment. However, security appliances are cost prohibitive in many cases, may require complicated setup, and can slow down a network. Many solutions require installing software on a device and sometimes having an IT worker install a system. Also, existing solutions often do not account for working with non-desktop computer environments such as smart phones, tablets, e-reader devices, TV-connected computing devices, game systems, and other internet enabled devices. Thus, users are left with expensive, inconvenient, and in some cases insecure network security. Thus, there is a need in the internet security field to create a new and useful system and method for securing network traffic. This invention provides such a new and useful method and system.

### BRIEF DESCRIPTION OF THE FIGURES

FIG. 1 is a schematic representation of a system of a preferred embodiment of the invention;

FIG. 2 is a flowchart representation of a method of a preferred embodiment of the invention;

FIG. 3 is schematic representation of a variation selectively returning an unmodified IP address;

FIG. 4 is schematic representation of a variation selectively returning an IP address of a replacement resource;

FIG. 5 is schematic representation of a variation selectively returning an IP address of a web proxy server;

FIG. 6 is a schematic representation of a variation configuring a DNS setting of a router;

FIG. 7 is a schematic representation of a variation accepting credentials and enabling account level access to the network; and,

FIG. 8 is a flowchart representation of a method of a preferred embodiment of the invention;

### DESCRIPTION OF THE PREFERRED EMBODIMENTS

The following description of the preferred embodiments of the invention is not intended to limit the invention to these preferred embodiments, but rather to enable any person skilled in the art to make and use this invention.

A system and method for securing network traffic of a preferred embodiment preferably uses DNS proxying and a second level web proxying to secure a network. The system and method preferably function to enable a network security solution with simple setup that enables all devices on a network to immediately benefit from the network security. The system and method are preferably used within a household, school, business, or other institution network environment. Many environments use a single router or network of routers to provide internet access to devices, and the system can preferably be used for any devices accessing the network from configured routers. The system and method preferably leverage the customization of DNS routing of the routers to provide transparent network security. The system and method alternatively leverage individual customization of DNS routing or other networking settings of devices accessing the internet from non-configured routers. The network security is preferably used to limit access to websites, portions of websites, actions on websites, access to internet files, access to any suitable network resource, and/or access to other internet traffic. The network security may additionally provide network security against malicious sites and network activity that may pose a threat to the security of a network or device. The system and method preferably do not require device setup and thus the network security is transparent to users of the network in many situations. When the site does enforce network security restrictions (e.g., Mocking access, preventing an action within a domain), a webpage or notification interface may be displayed. Additionally, the DNS proxying and second level web proxying preferably provide a single sign-on account component such that accounts can access different portions of the network according to their privileges. Typically, the system and method is configured to work with non-signed on accounts that receive restricted access and administrator accounts that receive substantially unrestricted access. The system and method of a preferred embodiment are preferably designed for use with cloud-based DNS and web proxying, but any suitable architecture may alternatively be used.

### 1. System for Securing Network Traffic

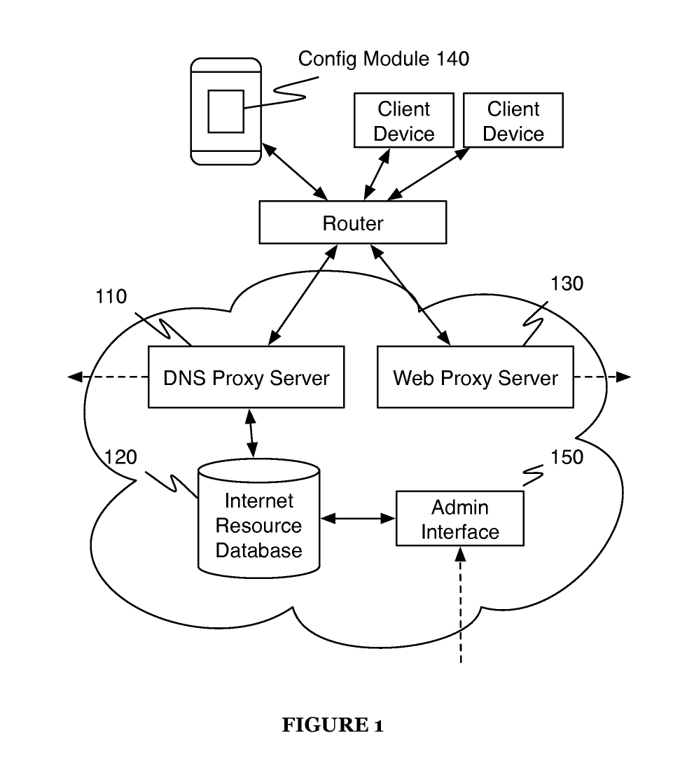

As shown in FIG. 1, a system for securing network traffic of a preferred embodiment includes a domain name system (DNS) proxy server 110, an internet resource database 120, and a web proxy server 130. The system may additionally include a router configuration module 140, and a network administration interface 150. The system is preferably used to inspect DNS requests and optionally HTTP traffic. The system is preferably a cloud service based solution for securing a network. The system usage is preferably shared by a plurality of users of the system. For example, individual homes and schools may all secure their network with substantially the same network security system. Additionally, configuration settings may be used to provide customized network security while still using the same cloud-based network security system. For example, configuration for one household may enable limited access to social networks but block all adult sites, while configuration settings for a business may restrict access to social networks, adult sites, and non-work related sites. The system may alternatively be configured for internal use or use in any suitable environment. Configuration settings may also be used to provide customized network security within an environment for particular machines or users. For example, configuration for a school may place more restrictions on computers in the classrooms of young children than on computers in the classrooms of older children.

The internet resource database 120 of a preferred embodiment functions to act as a repository of resources and their respective resource access levels. The internet resource database 120 preferably stores domain names, URI/URL resource addresses, file names, hashes of files, and/or any suitable identifiers of a network accessed resource. Each resource stored in the internet resource database 120 preferably includes a parameter indicating an associated resource access level. In one variation, there are three levels of resource access allowed: permitted, restricted, and partially-permitted. Permitted resources are typically resources that are fully trusted and deemed safe. Restricted resources are resources that are untrusted and are typically blocked. Partially-permitted resources are resources that have trusted and untrusted portions. Such sites may include social networks or sites featuring user-generated video or photos. Partially-permitted sites typically initiate the web proxy server 130 to provide second level proxying. Access is generally allowed but additionally monitored by the web proxy server 130. A resource stored in the internet resource database 120 may additionally or alternatively include an associated IP address. The IP address is preferably the IP address to be returned for the DNS query. Alternatively, a second DNS service may provide alternate IP addresses when appropriate.

The DNS proxy server no of a preferred embodiment functions to intercept and process any DNS queries made by a device on a network. Preferably all users/machines using a network must use the DNS proxy server no when attempting to access a site, thus enabling all devices on the entire network to be secured by the system. The DNS proxy server 110 is preferably transparent to users in that individual machines and users do not have to be specially configured for use with the system. To use the DNS proxy server, an internet router (e.g., the router a customer already uses to access the internet) is preferably configured to use the DNS proxy server 110 for all DNS queries. Alternatively, devices are individually configured to use the DNS proxy server no for all DNS queries. The DNS proxy server no preferably processes DNS queries in cooperation with the internet resource database 120. The DNS proxy server 110 accesses the internet resource database 120 for each query and determines a categorization of the query (e.g., permitted, partially-permitted, or restricted). Upon determining the categorization of the query, the DNS proxy server no preferably returns an IP address to the originating machine. The DNS proxy server no may return unmodified IP addresses (i.e., IP addresses directed to the domains contained in the DNS requests), replacement resource IP addresses, web proxy server IP addresses (IP addresses directed to the web proxy server 130), or any other suitable IP addresses. Replacement resource IP addresses preferably direct to a block page containing a notice of blocked content with a prompt or method for overriding the block page for users with appropriate credentials. In one variation, the DNS proxy server no categorizes queries as permitted, partially-permitted, or restricted. In this variation, the DNS proxy server no returns an unmodified IP address for queries categorized as permitted; for queries categorized as restricted, the DNS proxy server no returns a block page; and for queries categorized as partially permitted, the DNS proxy server no returns a web proxy server IP address. The DNS proxy server no may additionally include a cache of previously generated results. The DNS proxy server 110 is preferably configured by the network administration interface 150. For example, configuration may change the behavior of the DNS proxy server no based on conditions such as the time DNS requests are originated or the devices from which the DNS requests are originated. There may additionally be a plurality of DNS proxy servers 110 and any suitable load-balancing infrastructure to handle requests.

The web proxy server 130 of a preferred embodiment functions to provide a form of traffic monitoring for resources not fully trusted. Preferably, the web proxy server is configured to inspect and enforce a network security policy on web traffic. All non-encrypted traffic (e.g., HTTP) can preferably be inspected. Inspecting web traffic preferably involves looking at queries and detecting blocked file paths, query parameters, HTTP parameters, or any suitable aspect of the request. For example, the web proxy server 130 may allow access to a search engine but prevent the search engine from completing a search query that includes a blacklisted term. The web proxy server 130 is preferably enabled for monitoring of websites so that it may allow partial access. The web proxy server can modify traffic going to an outside resource, response from an outside response, redirect to a different page, or take any suitable action when enforcing a network security policy on network traffic. The configuration of the web proxy server 130 is preferably changed by the network administration interface 150. For example, configuration may change the behavior of the web proxy server 130 based on the current time, the devices connecting to the web proxy server 130, or the content of cross-domain cookies present on devices connecting to the web proxy server 130.

The router configuration module 140 of a preferred embodiment functions to automatically configure a network router for use with the DNS proxy server. The router configuration module 140 is preferably an application (e.g., mobile application or desktop application). The router configuration module 140 may alternatively be built into a router or be any suitable module capable of interfacing with a router. The router configuration module 140 is preferably configured with a plurality of wireless router configuration routines such that the router configuration module 140 can access a wireless router configuration interface and modify DNS settings of the wireless router to point DNS queries to the DNS proxy server no.

The network administration interface 150 of a preferred embodiment functions to enable enhanced access to the network. Enhanced access preferably encompasses a range of access from any access greater than standard access to complete access to the network and configuration options. The network administration interface 150 may preferably be accessed both directly (for example, visiting a website with configuration options) and transparently (for example, serving as an authentication broker to allow access to a restricted site). The network administration interface 150 preferably serves as the authentication broker for the block page. In one variation, the network administration interface 150 is preferably a sign in screen. Alternatively, access to the network administration interface may be granted via a single sign on identity provider such as Facebook or Google. Upon successfully authenticating as a user with enhanced access, a cross-domain access cookie is preferably set on that device enabling enhanced access for subsequent network activity. With enhanced access enabled, the DNS proxy server no and the web proxy server 130 preferably allow enhanced access to the network. The network administration interface 150 may additionally include a network activity data visualizer.

### 2. Method for Securing a Network

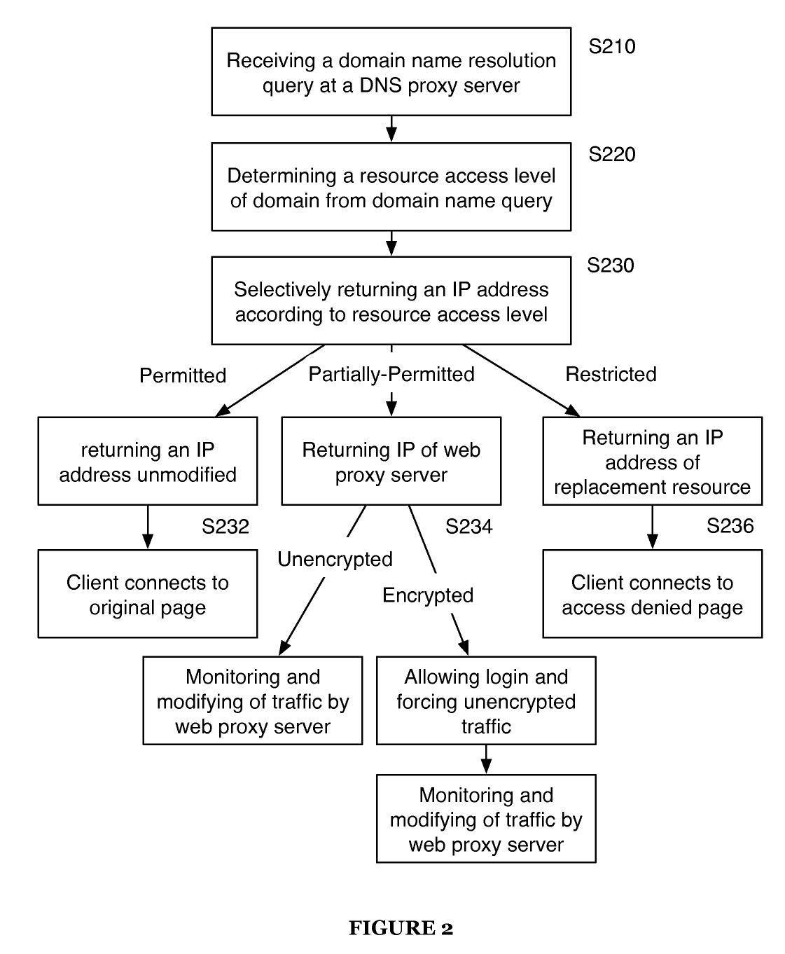

As shown in FIG. 2, a method for securing network traffic of a preferred embodiment includes receiving a domain-name resolution query at a DNS proxy server S210, determining a resource access level of a requested domain of the DNS resolution query based on an internet resource database; S220, includes selectively returning an IP address according to the resource access level S230, wherein selectively returning an IP address includes at least the options returning an IP address that is unmodified from requested domain for trusted sites S232, returning an IP address of a replacement resource for untrusted sites S236, or returning an IP address of a transparent web proxy server for the requested domain S234. The method is preferably configured to operate on a cloud based network security system such as the one described above, but the method may alternatively be implemented by any suitable system.

Step S210, which includes receiving a domain-name resolution query at a DNS proxy server, functions to obtain an initial request to access a network resource. The queries are preferably received at a DNS proxy server. A router or other suitable access point is preferably configured to use the DNS proxy server as the DNS server. The machines that initialized the request preferably do not need to perform any machine specific setup. All machines originating network access requests are preferably pre-configured to use a router which directs DNS queries to the DNS proxy server instead of a standard DNS server. Alternatively, machines are configured to direct DNS queries to the DNS proxy server by another suitable method.

Step S220, which includes, determining a resource access level of a requested domain of the DNS resolution query, preferably determines the resource access level based on an internet resource database. The internet resource database preferably at least includes resource access level parameters stored for a plurality of domains. In one preferred embodiment, domains are classified as permitted, partially-permitted, and restricted. Permitted resources are resources that are fully trusted and deemed safe. Restricted resources are resources that are untrusted, malicious, inappropriate, or otherwise undesirable for some users of a network. Restricted resources are typically blocked for users without permission to view. Partially-permitted resources are resources that have portions that could be permitted or restricted. For example, social networks or sites featuring user-generated video or photos may contain appropriate content and inappropriate content. Partially-permitted sites typically initiate second level web proxying by a web proxy server for network traffic at that domain so that restricted portions can be detected. If status of an network resource is unknown (e.g., it has not been pre-categorized), the resource may be automatically categorized using predefined heuristics, flagged for categorization by an administrator or other entity, receive a default resource access level, or receive any suitable treatment. Step S220 may additionally include determining the resource access level according to rules set by a network administration interface. These rules function to enable the method to enforce conditional access restrictions to resources. For example, an administrator may place time limits on access to a particular domain, restrict all access for a particular user, or setup any suitable network access restriction rule. Such customized restrictions are preferably configured in the network administration interface. For example, a parent may want to allow a child access to social networks for two hours each week. Similarly, a parent may want the control to “ground” a child and remove access to the network.

Step S230, which includes selectively returning an IP address according to the resource access level, functions to enact restrictions or allowances with the requested resource. Selectively returning an IP address preferably includes at least the options of returning an IP address that is unmodified from the requested domain for a permitted resource S232, returning an IP address of a replacement resource for a restricted resource S236, or returning an IP address of a transparent web proxy server for the requested domain S234. The step of selectively returning an IP address according to the resource access level may additionally or alternatively include other resource classifications and types of IP addresses that may be returned. In one embodiment, the step S234 returns an appended IP address of a transparent web proxy server for the requested domain. Resource access level may additionally be customized for a particular network, network account, user account, situational parameters (e.g., time of day or day of the week), or customized in any suitable manner. Rules for customization are preferably set using the network administration interface.

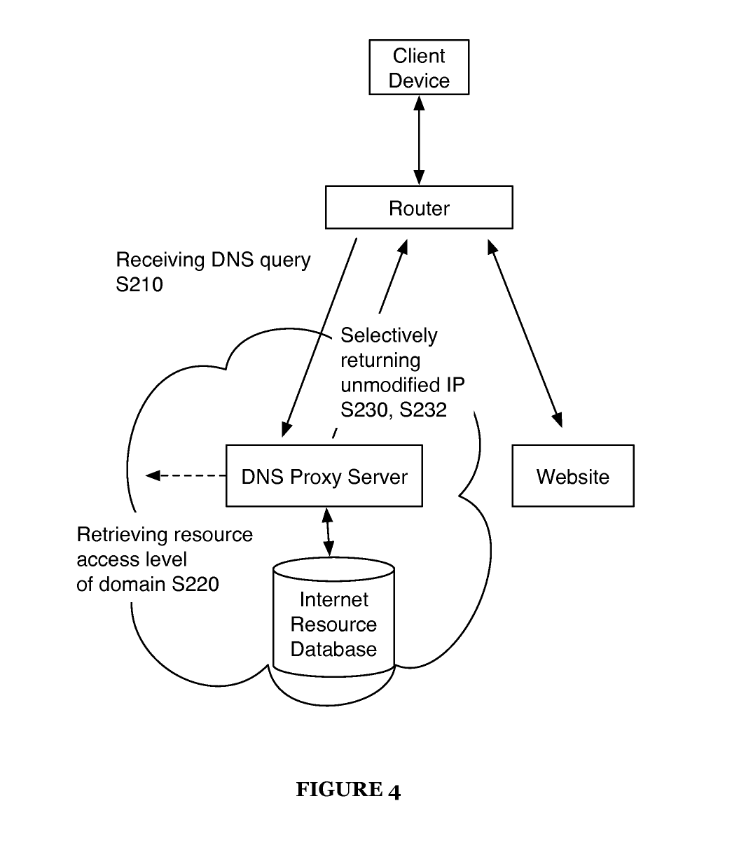

As shown in FIG. 4, Step S232, which includes returning an IP address that is unmodified from requested domain for a permitted resource, functions to provide an unmodified DNS response to the DNS query. The browsing of such a network resource preferably occurs without interference. Step S232 is preferably performed for permitted resources that are domains on a fully trusted domain. For example, when a user is trying to access a website of the local library, the internet resource database will typically assign an access level of permitted. Thus, when trying to access a page on the local library website, the DNS proxy server determines the domain of the local library to be a permitted site, and the IP address associated with the library website is preferably returned as expected from a DNS server. When returning the IP address, the DNS proxy server may additionally query other DNS servers if the IP address is not cached or stored.

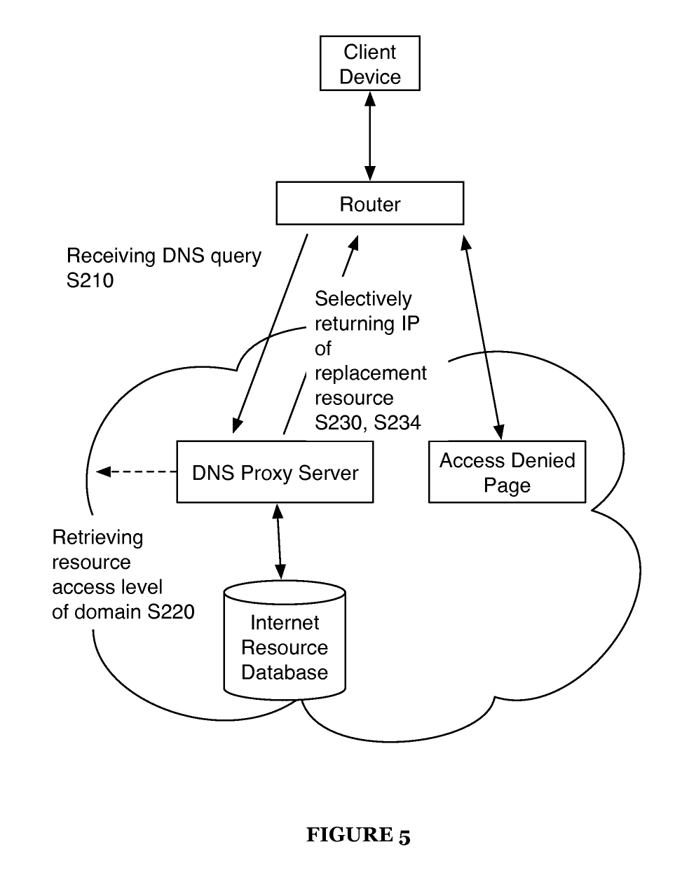

As shown in FIG. 5, Step S236, which includes returning an IP address of a replacement resource for a restricted resource, functions to block access to an untrusted website or file. Preferably, the IP address of the replacement resource is an IP address to an access denied page that indicates to the user that the network resource is restricted. The IP address may alternatively direct to any alternative page or resource. The access denied page preferably includes a prompt or option to sign in to a user or administrator account. Once authenticated a user can preferably access any restricted resource for which their account has acceptable privileges to access. A preferred example of authentication is as follows: When a user successfully logs in, an access cookie is preferably stored on the user's machine. When the user is directed to the replacement resource IP address again, the access cookie is preferably detected. Upon detection of the access cookie, the replacement resource preferably redirects the user's traffic to another IP address; for example, the web proxy server IP address or the unmodified IP address.

In many cases there are at least two classes of user: users without an account and those with administrator accounts. For example, in a household, kids and guests will not have an account and thus will not be able to access any restricted sites. The parents will preferably have an administrator account and will be capable of accessing any site they visit by logging in to their account when encountering an access denied page. As another example, in a school, students will preferably not have an account and not be able to access any restricted sites. Teachers will preferably be capable of accessing some restricted sites and changing some settings in the network administration interface, but will still have some restrictions. The school network administrator will preferably have complete control of the network administration interface.

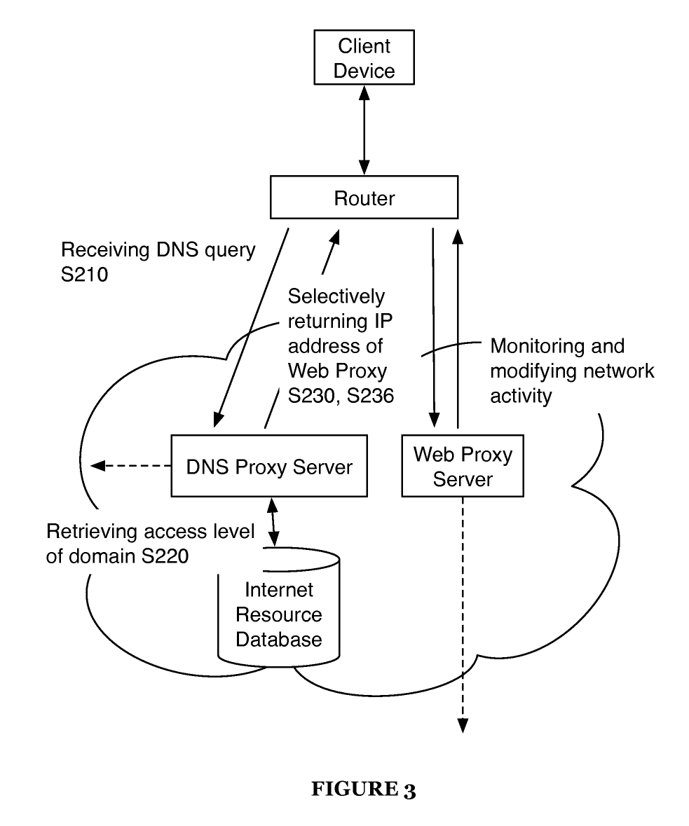

As shown in FIG. 3, Step S234, which includes returning an IP address of a transparent web proxy server for the requested domain functions to provide restricted access to resources through a web proxy. The IP address of a transparent web proxy server preferably directs HTTP traffic for the domain of the original DNS query through a controlled proxy server. The web proxy server preferably provides monitoring and modification of subsequent activity and resource access. In one embodiment, the step S234 returns an appended IP address of a transparent web proxy server for the requested domain. The appended IP address preferably includes the IP address of the transparent web proxy server with a cryptographic hash appended to it; the cryptographic hash conveys information about how the web proxy server should handle the IP address. For example, the cryptographic hash may convey information about the machine or user that originated the DNS request to the transparent web proxy server. Alternatively, the appended IP address includes the IP address of the transparent web proxy server with another type of string that conveys information to the web proxy server; e.g. a user ID. The cryptographic hash or other string preferably corresponds to information stored in a database such as a NOSQL key-value store database. By comparing the cryptographic hash or other string to information in the database, the authenticity of the hash can be verified; i.e. this can prevent a user from manually inserting a hash to gain unauthorized access.

For this selected option, the method may additionally include monitoring network traffic and modifying restricted traffic. For example, if during monitoring traffic restricted traffic is detected, that traffic may be modified by removing restricted content from the traffic while leaving unrestricted content. Modifying refers to changing the content of traffic in some way and does not encompass routing or redirection of traffic. HTTP, HTTPS, and other forms of network traffic preferably will pass through the web proxy server. By passing the IP address of the transparent web proxy server, the network security system is enabled to permit allowable resources and actions while restricting resources and actions on the partially-permitted site that are not allowed. A browser or internet enabled device will behave as if it has accessed the requested resource, but in actuality the transparent web proxy server is monitoring and regulating traffic. Traffic is preferably regulated by the web proxy server based on rules set by the network administration interface, the presence and content of an access cookie on a client machine of the traffic and/or the cryptographic hash if the web proxy server is connected to with an appended IP address. The web proxy server preferably performs content analysis on the traffic to identify restricted content. Content analysis preferably represents determining the content of traffic; for example, using a packet analyzer to capture and decode raw HTTP traffic. The content analysis is preferably used to filter or modify HTTP traffic based on the content of the traffic. For HTTP based access to websites, the transparent web proxy server can monitor all traffic and restrict or modify content based on terms or other heuristics. For example, search queries on a search engine with foul language may be modified by the web proxy server to return no results. In another variation, a web proxy server may additionally inspect files to detect malicious files as reported by the security community. The proxy server or additional component may calculate hashes of URL's or files to determine if the file matches a database of malicious files.

For SSL/HTTPS based website access, the network traffic is encrypted and thus cannot be monitored with the same tools used in unencrypted scenario. The method may additionally include detecting encryption handshake when web proxying. This preferably occurs when a site is being accessed over HTTPS using a SSL certificate of a server during a handshake. A domain is preferably detected during the handshake through a server name attribute or through some alternative parameter. The web proxy server may subsequently determine if the domain is restricted, permitted, or partially restricted. If the domain is restricted, the access may be blocked entirely. If the domain is permitted, the web proxy preferably hands client requests to the server and the server responses back to the client without making any modification to the tunneled SSL traffic. If the domain is partially permitted, the web proxy server passes the encrypted requests between the client and the server until determining the login process is complete and then forcing additional encrypted traffic (HTTPS) to be blocked, forcing unencrypted access. This preferably allows a client to complete a secure login process but then alter the rest of the network access so that the web proxy can monitor activity. The web proxy server preferably determines when a login process is complete through a combination of counting the number of transmitted bytes and the number of packets. Alternatively any suitable logic may be used to determine the end of the login process.

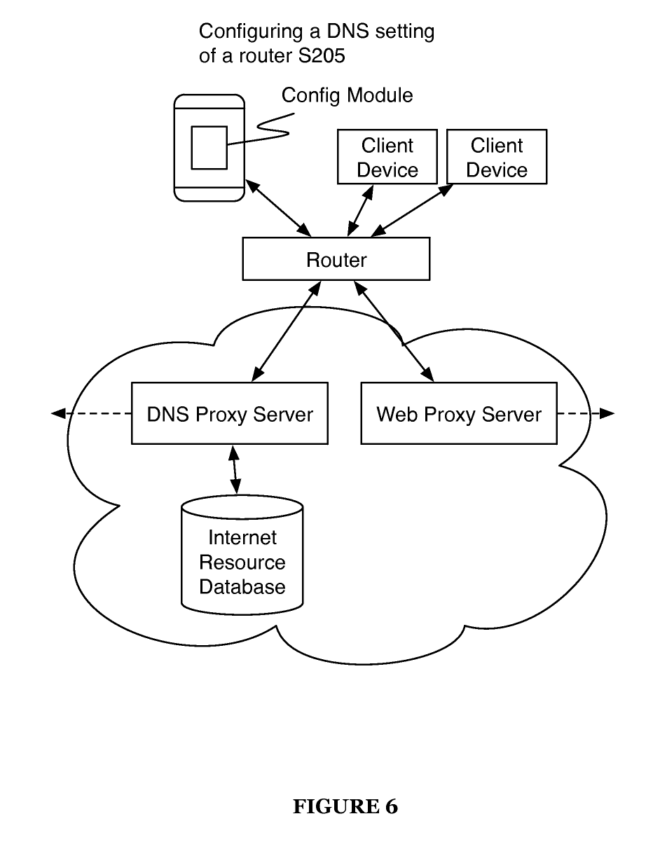

Additionally or alternatively, a method of a preferred embodiment may include configuring a DNS setting of a router S205 as shown in FIG. 6, which functions to set up a router of a network for use with the network security service. Step S205 preferably enables automatic configuration of at least one router. On a mobile app or application, repeatedly attempting login to a wireless router using a scripting engine and upon logging in to a router, setting a DNS configuration of the router to direct DNS resolution queries to the DNS proxy server. The repeated login attempt is preferably performed using HNAP or UPnP standardized administration protocols supported by many routers, programming in the API request-response protocol the router expects the browser to perform in order to set the DNS configuration, or through any suitable technique. A database of standard IP addresses, username and passwords for router makes and models may additionally be used when repeating login attempts. Users may alternatively configure routers manually or through any suitable means.

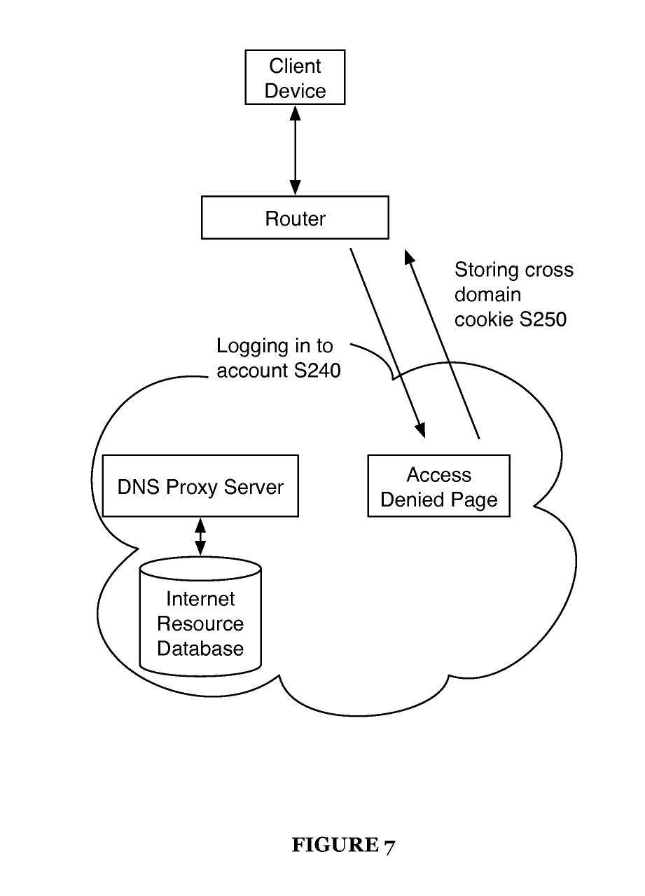

As mentioned above, a method of a preferred embodiment may additionally include accepting credentials S240 and enabling a level of enhanced access to the network S250 as shown in FIG. 7, which function to provide privilege based access to the network security system. The level of enhanced access in one variation functions to enable varied control over the treatment of permitted, restricted, and partially-permitted resources. For example, administrator level accounts preferably have unrestricted access to the network (i.e., restricted and partially-permitted resources). There may alternatively be any number types of accounts or individualized account settings to enable any suitable customization of network access. For example, one account may have a unique list of permitted, restricted, and/or partially-permitted websites. Accepting credentials S240 preferably includes using a single sign-on approach that includes installing a cross domain access cookie using with the web proxy server. With the web proxying server, the network security system preferably has access to web HTTP traffic. Thus once a user is authenticated a cookie is installed such that the user does not need to authenticate for other restricted or partially-restricted sites.

When served with a blocked page per step S236, the user can login to the network administration interface S240. The user may either have an account hosted in the Internet Resource Database 120 or alternatively have an account hosted in an external Resource Database that provides Web Single Sign On (Web SSO) capabilities such as Microsoft's Active Directory Federation Services (MS ADFS), Google Apps for Business/Education etc. If the account is hosted in the internet resource database 120, credentials are checked within the system. However, if the account is hosted externally, a simple web HTTP redirection to the external SSO provider can be performed which preferably authenticates and redirects back to the system with a cryptographically signed token and access-level information. For example, with Google Apps for Education (GAfE), an IT admin can place all the teachers in a group call “Staff” and whenever a teacher signs in using the SSO service, this access-level (“Staff”) is shared with the cloud based network security system. This functions to enable the cloud based network security system to avoid having to recreate accounts for all 100 s or 1000 s of users from the school database and simply use the authentication-token and the access-level to determine protection policy for the user. After the one-time login, the logged-in status is captured in an access cookie on the network administration interface 150. Whenever the user visits a blocked resource, the web proxy server 130 simply checks with the network administration interface 150 to see if an access cookie exists for the user at a privileged access level. If it does, the access is authorized. If not, the access is denied.

The account level access in another variation functions to provide data insight into usage of the network. The method may additionally include generating reports on network traffic such as time spent on particular domains, sites accessed, sites blocked, action reports such as search queries or messages, and/or any suitable report on network usage. An administrator or account with the correct privilege setting can preferably access the reports.

3. Method for Identifying users in the Cloud

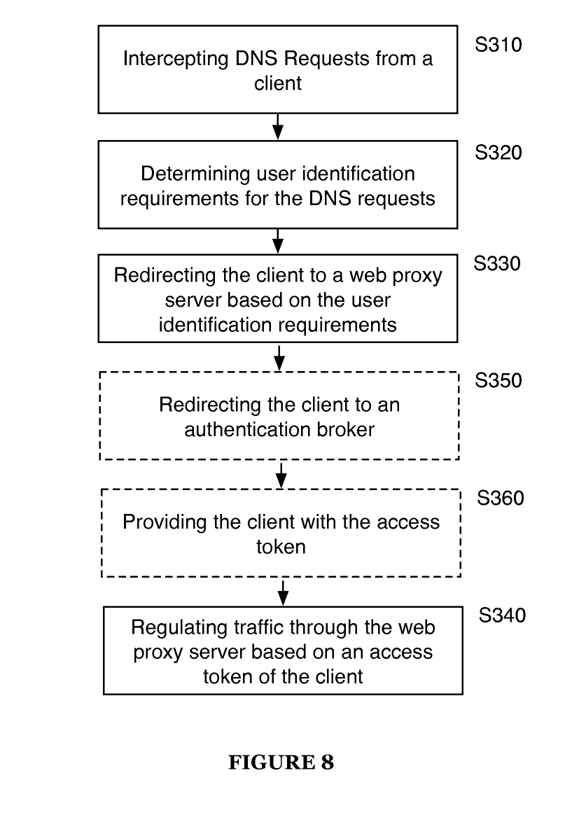

As shown in FIG. 8, a method for identifying users in the cloud includes intercepting domain-name resolution requests from a client S310, determining user identification requirements for the DNS requests S320, redirecting the client to a web proxy server based on the user identification requirements S330, and regulating traffic through the web proxy server based on an access token of the client S340.

The method is preferably configured to operate on a cloud based network security system such as the one described above, but the method may alternatively be implemented by any suitable system.

Step S310, which includes intercepting domain-name resolution requests (i.e., DNS requests) from a client, functions to obtain an initial request to access a network resource. A client is preferably any device able to send a DNS request. The requests are preferably received at a DNS proxy server. A router or other suitable access point is preferably configured to use the DNS proxy server as the primary DNS server. The machines that initialized the request preferably do not need to perform any machine specific setup. All machines originating network access requests are preferably pre-configured to use a router which directs DNS queries to the DNS proxy server instead of a standard DNS server. Alternatively, machines are configured to direct DNS queries to the DNS proxy server by another suitable method.

Step S320, which includes determining user identification requirements for the DNS requests, preferably determines the user identification requirements based on an internet resource database. User identification requirements preferably include whether an internet resource requires user identification or authentication to be accessed through the DNS server. The internet resource database preferably at least includes user identification requirements stored for a plurality of domains. In one preferred embodiment, user identification requirements are based on domain classifications. Domains are classified as permitted, partially-permitted, and restricted. Permitted resources are resources that are fully trusted and deemed safe. Restricted resources are resources that are untrusted, malicious, inappropriate, or otherwise undesirable for some users of a network. Restricted resources are typically blocked for users without permission to view. Partially-permitted resources are resources that have portions that could be permitted or restricted. For example, social networks or sites featuring user-generated video or photos may contain appropriate content and inappropriate content. Partially-permitted sites typically initiate second level web proxying by a web proxy server for network traffic at that domain so that restricted portions can be detected. If status of an network resource is unknown (e.g., it has not been pre-categorized), the resource may be automatically categorized using predefined heuristics, flagged for categorization by an administrator or other entity, receive a default resource access level, or receive any suitable treatment. Step S220 may additionally include determining the resource access level according to rules set by a network administration interface. These rules function to enable the method to enforce conditional access restrictions to resources. For example, an administrator may place time limits on access to a particular domain, restrict all access for a particular user, or setup any suitable network access restriction rule. Such customized restrictions are preferably configured in the network administration interface. For example, a parent may want to allow a child access to social networks for two hours each week. Similarly, a parent may want the control to “ground” a child and remove access to the network.

Step S330, which includes redirecting the client to a web proxy server based on the user identification requirements, functions to redirect the client to a web proxy server if the client attempts to access resources that require user identification. The client is preferably redirected by the DNS server returning an IP address of the web proxy server. The IP address of the web proxy server preferably directs HTTP traffic for the domain of the original DNS query through a controlled proxy server. The web proxy server preferably provides monitoring and modification of subsequent activity and resource access.

Step S340, regulating traffic through the web proxy server based on an access token of the client, functions to regulate traffic based on information present in an access token presented by the client. The access token is preferably a cookie, but may alternatively be a cryptographic hash or any other suitable method for authenticating the client with the web proxy server. The access token preferably functions to convey information about the machine or user that originated the DNS request to the web proxy server. The access token preferably conveys information about how the web proxy server should handle the IP address. If the access token is a cryptographic hash, the cryptographic hash or other string preferably corresponds to information stored in a database such as a NOSQL key-value store database. By comparing the cryptographic hash or other string to information in the database, the authenticity of the hash can be verified; i.e. this can prevent a user from manually inserting a hash to gain unauthorized access. Regulating traffic preferably includes monitoring network traffic and modifying restricted traffic. For example, if during monitoring traffic restricted traffic is detected, that traffic may be modified by removing restricted content from the traffic while leaving unrestricted content. Modifying refers to changing the content of traffic in some way and does not encompass routing or redirection of traffic. HTTP, HTTPS, and other forms of network traffic preferably will pass through the web proxy server. By passing the IP address of the web proxy server, the network security system is enabled to permit allowable resources and actions while restricting resources and actions on partially-permitted sites that are not allowed. A browser or internet enabled device will behave as if it has accessed the requested resource, but in actuality the web proxy server is monitoring and regulating traffic. Traffic is preferably regulated by the web proxy server based on rules set by the network administration interface, the presence and content of an access token on a client machine of the traffic, or a combination of the two. The web proxy server preferably performs content analysis on the traffic to identify restricted content. Content analysis preferably represents determining the content of traffic; for example, using a packet analyzer to capture and decode raw HTTP traffic. The content analysis is preferably used to filter or modify HTTP traffic based on the content of the traffic. For HTTP based access to websites, the web proxy server can monitor all traffic and restrict or modify content based on terms or other heuristics. For example, search queries on a search engine with foul language may be modified by the web proxy server to return no results. In another variation, a web proxy server may additionally inspect files to detect malicious files as reported by the security community. The proxy server or additional component may calculate hashes of URL's or files to determine if the file matches a database of malicious files.

The method may additionally include Step S350, which includes redirecting the client to an authentication broker. The client is preferably redirected by the DNS server returning an IP address of the authentication broker. The authentication broker is preferably a server connected to a database of users and permissions, but may alternatively be any other mechanism that enables authentication. For example, the authentication broker may be a third party service that performs authentication such as the federated login for Google account users.

The method may additionally include Step S360, which includes providing the client with the access token. Providing the access token preferably includes authenticating the client. Authentication preferably occurs by taking a user login name and password and verifying them against a database, but may alternatively occur in any other suitable manner. For example, authentication may be performed by checking that the client IP address or MAC address matches those in a database. Authentication may also occur through a third party service that provides Web Single Sign On (Web SSO) capabilities such as Microsoft's Active Directory Federation Services (MS ADFS), or the federated login for Google users. After authentication, providing the access token preferably includes providing an access token to the client. This is preferably accomplished by storing an access cookie with the client, but may alternatively be accomplished by supplying the client with a cryptographic hash, URL code, or other identification code. This may alternatively be accomplished by any means that enable the client to provide identification to the proxy server.

An alternative embodiment preferably implements the above methods in a computer-readable medium storing computer-readable instructions. The instructions are preferably executed by computer-executable components preferably integrated with a network security system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method comprising:
receiving DNS queries sent over the internet;
selecting from three resource access levels for the DNS queries based on an internet resource database and rules set by a network administration interface, wherein the three resource access levels are a permitted level, a restricted level, and a partially permitted level;
returning an unmodified IP address for the permitted level DNS queries;
returning a replacement resource IP address for the restricted level DNS queries, wherein the replacement resource IP address is directed to a block page that allows authentication and, upon successful authentication, stores an access cookie on the client machine;
returning a web proxy server IP address for the partially permitted level DNS queries;
recognizing the access cookie on the client machine and redirecting traffic, sent from the client machine and originally directed to the replacement resource IP address, to the web proxy server IP address;
performing a content analysis of HTTP traffic directed to the web proxy server IP address; and
monitoring and modifying the HTTP traffic directed to the web proxy server IP address based on the rules set by the network administration interface, the access cookie and the content analysis.

2. The method of claim 1 further comprising generating a cryptographic hash based on the access cookie; appending the cryptographic hash to the web proxy server IP address to create an appended web proxy server IP address; redirecting traffic, sent from the client machine and originally directed to the replacement resource IP address, to the appended web proxy server IP address; performing a content analysis of redirected HTTP traffic directed to the appended web proxy server IP address; and monitoring and modifying redirected HTTP traffic directed to the appended web proxy server IP address based on the rules set by the network administration interface, the content analysis of the redirected HTTP traffic, and the cryptographic hash.

3. The method of claim 1 further comprising redirecting traffic, sent from the client machine and originally directed to the replacement resource IP address, to an appended web proxy server IP address, wherein the appended web proxy server IP address comprises the web proxy server IP address with an appended cryptographic hash; performing a content analysis of redirected HTTP traffic directed to the appended web proxy server IP address; and monitoring and modifying redirected HTTP traffic directed to the appended web proxy server IP address based on the rules set by the network administration interface, the content analysis of the redirected HTTP traffic, and the appended cryptographic hash.

4. The method of claim 3, further comprising detecting an encryption handshake for encrypted traffic directed to the web proxy server address; passing encrypted traffic after detecting the encryption handshake; detecting a successfully completed encrypted login process; and Mocking encrypted traffic after detecting the successfully completed encrypted login process.

5. The method of claim 3, wherein selecting further comprises selecting based on heuristic analysis of domains referenced by the DNS queries.

6. The method of claim 4, wherein selecting further comprises selecting based on heuristic analysis of domains referenced by the DNS queries.

7. A method comprising:
receiving DNS queries;
determining resource access levels for the DNS queries based on an internet resource database, wherein the resource access levels comprise a first level, a second level, and a third level;
returning an unmodified IP address for the first level DNS queries;
returning a replacement resource IP address for the second level DNS queries;
returning a web proxy server IP address for the third level DNS queries; and
regulating HTTP traffic directed to the web proxy server IP address.

8. The method of claim 7, wherein determining resource access levels further comprises determining resource access levels based on rules set by a network administration interface.

9. The method of claim 8, wherein regulating the HTTP traffic comprises monitoring and modifying the HTTP traffic based on the rules set by the network administration interface.

10. The method of claim 9, further comprising performing a content analysis of the HTTP traffic directed to the web proxy server IP address; wherein regulating the HTTP traffic further comprises monitoring and modifying the HTTP traffic based on the content analysis.

11. The method of claim 10, further comprising storing an access cookie on a client machine; wherein regulating the HTTP traffic further comprises monitoring and modifying the HTTP traffic based on the access cookie.

12. The method of claim 8, wherein the replacement resource IP address is directed to a block page that allows authentication.

13. The method of claim 12, further comprising storing an access cookie on a client machine upon successful authentication through the block page; storing an access cookie on the client machine; and recognizing the access cookie on the client machine and redirecting traffic, sent from the client machine and originally directed to the replacement resource IP address, to the web proxy server IP address.

14. The method of claim 13, wherein regulating the HTTP traffic further comprises monitoring and modifying the HTTP traffic based on the access cookie.

15. The method of claim 12, further comprising storing an access cookie on a client machine upon successful authentication through the block page; storing an access cookie on the client machine; and recognizing the access cookie on the client machine and redirecting traffic, sent from the client machine and originally directed to the replacement resource IP address, to an appended web proxy server IP address, wherein the appended web proxy server IP address comprises the web proxy server IP address with an appended cryptographic hash.

16. The method of claim 15, further comprising monitoring and modifying redirected HTTP traffic directed to the appended web proxy server IP address based on the appended cryptographic hash.

17. The method of claim 9 further comprising detecting an encryption handshake for encrypted traffic directed to the web proxy server address; passing encrypted traffic after detecting the encryption handshake; detecting a successfully completed encrypted login process; and Mocking additional encrypted traffic after detecting the successfully completed encrypted login process.

18. The method of claim 17, wherein detecting the successfully completed encrypted login process comprises at least one of counting transmitted bytes and counting packets.

19. A method for identifying users in the cloud comprising:
intercepting DNS requests from a client;
determining user identification requirements for the DNS requests;
redirecting the client to a web proxy server based on the user identification requirements; and
regulating traffic through the web proxy server based on an access token of the client.

20. The method of claim 19 further comprising redirecting the client to an authentication broker; and providing the client with the access token.

21. The method of claim 20 wherein the access token is a cryptographic hash.

22. The method of claim 20 wherein regulating traffic comprises monitoring and modifying the traffic based on the access token.

23. The method of claim 22 wherein regulating traffic further comprises monitoring and modifying the traffic based on rules set by the network administration interface.
